(19) United States
(12) Patent Application Publication
(10) Pub. No.: US 2003/0226751 A1
(43) Pub. Date: Dec. 11, 2003

(54) Corona discharge ozone generator

(76) Inventor: Stephen P. Kasten, Prescott, AZ (US)

Correspondence Address: C. Robert von Hellens, CAHILL, VON HELLENS & GLAZER P.L.C., Suite 155, 2141 E. Highland Avenue, Phoenix, AZ, 85016, US

(21) Appl. No.: 10/457,284

(22) Filed: Jun. 9, 2003

Related U.S. Application Data
(60) Provisional application No. 60/387,797, filed on Jun. 11, 2002.

(51) Int. Cl. C01B 13/11

(52) U.S. Cl. 204/176; 422/186.07

(57) ABSTRACT

Loosely packed electrically conductive material is retained within a tube of dielectric material. A sheath of electrically conductive material surrounds the tube. A pair of electrodes, adapted to be connected to a source of high voltage are electrically connected to the material and the sheath, respectively, to generate corona discharge between the material and the tube and between elements of the material to transform oxygen molecules in a gas passing through the material in the tube into ozone to produce an ozone enriched outflow of gas.

### CROSS REFERENCE TO RELATED APPLICATION

The present application relates to subject matter described in and claims priority to a provisional application entitled “Ozone Generator”, assigned Serial No. 60/387,797 and assigned a filing date of Jun. 11, 2002 and describing an invention made by the present inventor.

### BACKGROUND OF THE INVENTION

Ozone generators have been used for decades to convert molecules of oxygen present in the air to molecules of ozone to produce ozone enriched air. The ozone enriched air serves as a powerful oxidizer and is often used as a disinfectant. A particular widespread use of the ozone enriched air is that of entraining the air in water to destroy any bacteria (or other organic matter) present as a result of the oxidizing effect of the ozone. Such water purification may be for purposes of purifying drinking water or water used as a rinse in a dental office. Other uses include purification of the water in aquariums. These uses are of relatively low volumetric water flow rates. On a larger scale and which require more massive ozone generators other uses include purification of the water in swimming pools, spas and the like.

Ozone generators are generally of two types. The first type utilizes ultra violet (UV) radiation to irradiate a flow of air. Some of the radiated oxygen molecules are transformed into ozone molecules to produce an ozone enriched flow of air. A second type uses corona discharge between two electrodes to convert oxygen molecules in air flowing therebetween into ozone molecules. This also produces an ozone enriched air flow.

### SUMMARY OF THE INVENTION

A corona discharge ozone generator includes a tube of a dielectric composition and contains loosely packed electrically conductive material to provide a passageway through which air to be ozonated is passed. A tape or sheet of electrically conductive composition is wrapped about the tube in general proximity with the material within the tube. An apertured plug is disposed at each end of the tube to loosely retain the electrically conductive material therebetween; the plugs may also support opposed ends of the tape or sheet or a component thereof. A first electrode is in contact with the material and a second electrode is in contact with the tape or sheet. The first and second electrodes are connected to a source of electrical power to provide a voltage across the electrodes of sufficient value to cause corona discharge to occur. By impressing a significant voltage across the electrically conductive material and the tape or sheet via the first and second electrodes associated with therewith, corona discharges will occur within the tube and across air spaces between particles of the material. The corona discharge occurring within the tube will transform oxygen molecules present in an air flow through the tube into ozone molecules and result in an ozone enriched outflow of air.

It is therefore a primary object of the present invention to provide a corona discharge ozone generator.

Another object of the present invention is to provide a scalable corona discharge ozone generator.

Yet another object of the present invention is to provide an inexpensive corona discharge ozone generator.

Still another object of the present invention is to provide a corona discharge ozone generator that may be flooded without short circuiting the electrical power supply.

A further object of the present invention is to provide a corona discharge ozone generator which will not burn up upon intrusion of water into a tube for accommodating an air flow subjected to the corona discharge.

A yet further object of the present invention is to provide a method for generating ozone by corona discharge.

A still further object of the present invention is to provide a disposable corona discharge ozone generator.

These and other objects in the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a conventional prior art corona discharge ozone generator;

FIG. 2 is a cross sectional view of a corona discharge ozone generator incorporating the present invention;

FIG. 2A representatively illustrates a power source for the corona discharge ozone generator; and

FIG. 3 is a cross sectional view taken along lines 3-3, as shown in FIG. 2.

### DESCRIPTION OF THE PREFERRED EMBODIMENT

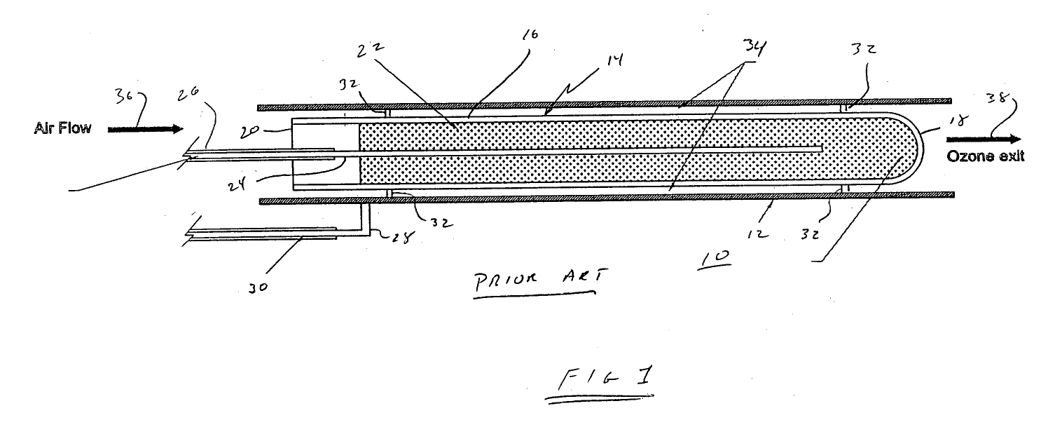

Referring to FIG. 1, there is shown a prior art ozone generator using corona discharge. An electrically conductive shell or tube 12 concentrically encloses an inner electrode assembly 14. The assembly includes a glass tube 16 (like a test tube) having a closed end 18 and an open end 20. The tube is filled with tightly packed electrically conductive elements 22, which elements may be electrically conductive carbon powder, metal filings, etc. An electrode 24 is in electrical communication with elements 22; typically, the electrode may include an insulating sheath 26 external of elements 22. An electrode 28 is in electrical communication with tube 12 and includes a sheath 30 of electrically insulting material. It is preferable that inner electrode assembly 14 be maintained concentrically within tube 12. For this purpose, a plurality of spacers 32 may be employed. As the air flow through the ozone generator flows through annular space 34 intermediate tubes 12 and 16, spacers 32 must be configured to have a minimal restriction upon such air flow. In operation, air flow enters one end of ozone generator 10, as represented by arrow 36 and exits from the ozone generator, as represented by arrow 38.

As is well known, a high voltage is impressed upon electrodes 24 and 28 by a suitable power source (not shown). The resulting high potential between elements 22 and tube 12 will result in periodic corona discharges across annular space 34. As air flows through the annular space, and is subjected to repeated corona discharges, some of the oxygen molecules in the air will be transformed into ozone molecules. Thereby, the air outflowing from ozone generator 10 will be ozone enriched.

Certain problems exist with prior art ozone generators of the type shown in FIG. 1. These problems include a difficulty of maintaining a constant size annular space between the two electrodes. Without a constant air space, there will be localized arcing with resulting pitting and deterioration of tube 12. The channeling of an air flow into and out of ozone generator 10 presents problems of insuring an even air flow through the annular space and tight manufacturing tolerances are necessary, which increases the costs of manufacture. The products resulting from corrosion will accumulate and must be periodically mechanically removed. Such removal requires disassembly and the attendant maintenance costs are significant. To minimize corrosion exacerbated by high humidity air passing through the ozone generator, an air drying apparatus may need to be used external of the ozone generator which further increases the costs and practical aspects.

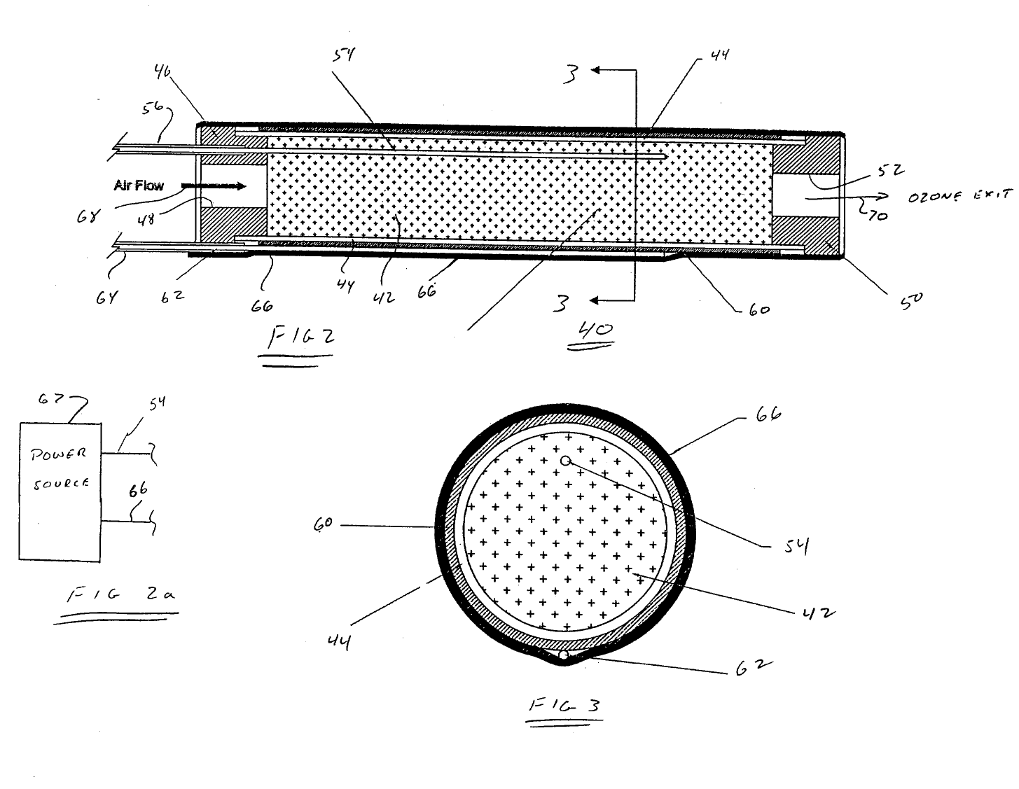

Referring jointly to FIGS. 2, 2A and 3, an ozone generator 40 embodying the present invention will be described. Electrically conductive material 42, such as metal machine chips, metal wool particles, shredded metal foil, metal foil balls, etc., are loosely packed within a tube 44 of dielectric material. A plug 46 of dielectric material extends into one end of tube 44 and includes a passageway 48 extending therethrough. A second plug 50 is secured in the other end of tube 44 and it also includes a passageway 52 extending therethrough. Material 42 is loosely packed between the two plugs to a degree of looseness sufficient to accommodate an air flow therethrough. It is to be understood that an apertured flange, wall, dam, cap or the like may be used in place of either or both of plugs 46, 50. An electrode 54 extends through and is secured by plug 46 into electrical contact with material 42. A sheath 56 encircles electrode 54 externally of plug 46. An electrically conductive sheath 60 extends about tube 44 generally coincident with material 42 within the tube. The sheath may be an electrically conductive foil wrap, such as aluminum foil, or a wrapped length of electrically conducting tape. Alternatively, an electrically conductive coating may be applied about tube 44. An electrode 62 is in electrical contact with sheath 60; the electrode may include an electrically insulating sheath 64 extending externally from plug 46. A covering 66 of electrically insulating material extends about sheath 60. This covering may be shrink type tubing, PVC type adhesive tape, etc. Electrodes 54, 62 are connected to conventional electrical conductors (also identified by reference numerals 54, 63), which in turn are connected to a source 67 of electrical power.

In operation, a high voltage is impressed upon electrodes 54 and 62. The resulting high potential will cause arcing in the air spaces adjacent material 42 in a generally random manner. A source of air flow enters ozone generator 40 through passageway 48 of plug 46, as depicted by arrow 68. The air flow in and about material 42 will be subjected to the electrical discharges occurring about the material within tube 44 and oxygen molecules will be transformed into ozone molecules. Ozone enriched air will exhaust through passageway 52 in plug 50, as depicted by arrow 70.

It is to be understood that tube 40 is preferably cylindrical to minimize costs and permit simple manufacture of plugs 46, 50. However, the tube may be oval, square, rectangular, etc. in cross section depending upon specific requirements attendant its use or for other reasons. Furthermore, it is preferable that material 42 be of non-corrosive material, such as stainless steel or aluminum to provide longevity despite being subjected to the corrosive effects of water or other liquids or gases.

As is evident from the above description and illustrations in the drawings, ozone generator 40 differs from prior art ozone generators in that it employs a flow of air through a packing media serving the purpose of an electrode. This eliminates problems of uneven air (gas) flows and requirements for high tolerance components. Moreover, the corona discharge occurs by arcing between elements of material 42 and tube 44, which tube is of dielectric material, such as a glass tube or a ceramic tube. As noted above, arcing may also occur through the air spaces between elements of material 42.

Ozone generator 40 is a very simple apparatus and relatively inexpensive to manufacture. The attendant low cost renders it particularly useful as a consumer product for use with spas, pools, aquariums and devices having a relatively small volume of water to be treated. In fact, ozone generator 40 is so inexpensive that replacement, instead of repair, would be more fiscally prudent.

Because of the convoluted air flow through loosely packed material 42, significant mixing of the ozone created with the air occurs such that the ozone enriched air discharged from the ozone generator is relatively homogenous.

In any ozone generator, deposits of foreign materials conveyed by the inflowing air and corrosion will occur. Because of the arcing that occurs between elements of the loosely packed material, such deposits and corrosion may be burned away. Furthermore, by simply shaking or vibrating the ozone generator, the elements of material 42 will become rearranged and different surface areas will be exposed to arcing.

It is to be noted that the inlet end of tube 44 may be packed with a desiccant to remove moisture from the inflowing air. This will reduce contamination of material 42 due to moisture and possible formation of nitric acid. Furthermore, inlet and outlet screens may be disposed intermediate the passageway of the respective plug and material 42 or at the other end of the plug (or at the inlet of tube 44) to prevent incursion of foreign matter.

If the electrode represented by sheath 60 and electrode 62 is sealed against contact with water, shorting between electrode 62 and electrode 54 will not occur due the presence of water. Thus, the ozone generator is resistant to damage due to flooding and it can readily be used in environments where flooding is a potential problem.

The simplicity of the components eliminates any constraint on size. That is, not one of the parts/components must be especially made of a specific configuration for a specific size of the ozone generator. Thus, it is easily scalable to accommodate any ozone generating requirement or air flow requirement.

I claim:

1. A corona discharge ozone generator, said generator comprising in combination:
a) a tube of dielectric material;
b) loosely packed electrically conductive material disposed within said tube;
c) plug means for retaining said material within said tube, each of said plug means including a passageway for air flow into and out of said tube;
d) a first electrode in electrical contact with said material;
e) a sheath of electrically conductive material disposed about said tube; and
f) a second electrode in electrical contact with said sheath.

2. The generator as set forth in claim 1 including an insulator for insulating said sheath.

3. The generator as set forth in claim 1 wherein one of said plug means supports said first electrode.

4. The generator as set forth in claim 1 including a source of electrical power adapted to be electrically connected to said first and second electrodes for providing a voltage sufficient to cause corona discharge within said tube.

5. The generator as set forth in claim 1 wherein said tube is cylindrical.

6. The generator as set forth in claim 1 wherein said material is selected from a group consisting of metal machine chips, metal wool particles, shredded metal foil, and metal foil balls.

7. A method for generating ozone to produce an ozone enriched gas, said method comprising the steps of:
a) introducing the gas to an inlet of a tube of dielectric material;
b) channeling the gas to flow about loosely packed electrically conductive material disposed in the tube;
c) creating a corona discharge within the tube to act on oxygen molecules of the gas to transform the oxygen molecules into ozone molecules by applying a high voltage to the material and to an electrically conductive sheath disposed about the tube; and
d) exhausting the ozone enriched gas from the tube.

8. The method as set forth in claim 7 including the step of retaining the material within the tube with a pair of plug means disposed on opposite sides of the material.

9. The method as set forth in claim 7 including the step of introducing the gas into the tube through one of the plug means and the step of discharging the gas from the tube through the other of the plug means.

10. The method as set forth in claim 7 including the step of supporting an electrode in electrical contact with the material with one of the plug means.

11. The method as set forth in claim 10 including the step of further supporting a further electrode in electrical contact with the sheath.

12. A method for producing an ozone enriched gas, said method comprising the steps of:
a) passing a gas through a tube of dielectric material;
b) channeling the flow of gas within the tube to flow about loosely packed electrically conductive material disposed within the tube;
c) applying a voltage between the material and an electrode external to the tube to cause corona discharge within the tube in proximity to the material, exercise of said step of applying resulting in transformation of oxygen molecules of the gas into ozone molecules to produce the ozone enriched gas.

13. The method as set forth in claim 12 including the step of retaining the material within the tube with a pair of plug means disposed on opposite sides of the material.

14. The method as set forth in claim 12 including the step of introducing the gas into the tube through one of the plug means and the step of discharging the gas from the tube through the other of the plug means.

15. An ozone generator for producing an ozone enriched gas, said generator comprising in combination:
a) a tube of dielectric material;
b) loosely packed electrically conductive material disposed within said tube;
c) an apertured element disposed on each of opposed sides of said material for retaining said material with said tube and to accommodate a flow of an oxygen containing gas through said tube;
d) a first electrode in electrical contact with the material and a second electrode disposed external to said tube for applying a voltage sufficient to cause corona discharge within said tube and attendant said material to transform oxygen molecules of the gas within said tube into ozone molecules and thereby produce the ozone enriched gas.

16. The method as set forth in claim 15 wherein the gas is air.

17. The method as set forth in claim 15 including an electrically conductive sheath disposed about said tube, said second electrode being in electrical contact with said sheath.

18. The method as set forth in claim 15 wherein each of said apertured elements is an apertured plug supported by said tube.

19. The method as set forth in claim 15 wherein said first electrode extends into said material.

20. The method as set forth in claim 19 wherein said material is selected from a group consisting of metal machine chips, metal wool particles, shredded metal foil, and metal foil balls.
